(19) United States
(12) Patent Application Publication
(10) Pub. No.: US 2014/0302695 A1
(43) Pub. Date: Oct. 9, 2014

(54) CONNECTOR

(71) Applicant: YAZAKI CORPORATION, Tokyo (JP)

(72) Inventor: Takenori Ohmura, Kakegawa-shi (JP)

(73) Assignee: YAZAKI CORPORATION, Tokyo (JP)

(21) Appl. No.: 14/260,739

(22) Filed: Apr. 24, 2014

Related U.S. Application Data
(63) Continuation of application No. PCT/JP2012/006735, filed on Oct. 22, 2012.

(30) Foreign Application Priority Data
Oct. 24, 2011 (JP) 2011-232805

(51) Int. Cl. H01R 13/447

(52) U.S. Cl. CPC H01R 13/447
USPC 439/136

(57) ABSTRACT

An object is to provide a connector which can prevent a foreign object from contacting an insert and which can reduce insertion force for inserting the insert into a mating terminal. A connector includes a rod-shaped insert to which a mating terminal is fitted from front, a housing having a tube-shaped terminal receiving portion arranged to receive the insert, an insulating contact prevention member arranged between a peripheral wall of the terminal receiving portion and the insert so as to slide along a terminal fitting direction of the mating terminal and the insert, and an elastic member which exerts a force on the contact prevention member toward the front end side of the insert. The contact prevention member includes a tapered face slanted radially-outward towards the rear side of the terminal fitting direction.

### TECHNICAL FIELD

The present invention relates to a connector used, for example, for a connector of a charging cable of an electric vehicle, the connector including a rod-shaped insert to which a mating terminal connected to a battery of the electric vehicle is fitted from the front, a housing having a tubular terminal receiving portion arranged to receive the insert, a contact prevention member slidably arranged between a peripheral wall of the terminal receiving portion and the insert, and an elastic member which exerts a force on the contact prevention member toward the front end side of the insert.

### BACKGROUND ART

A conventional connector 101 shown in FIGS. 5 through 7 constitutes a connector of a charging cable (hereinafter called the charging connector 110) for charging a battery of an electric vehicle. The connector 101 includes a terminal portion 103 having a rod-shaped insert 102 to which a mating terminal (not shown) is fitted from the front, a housing 150 having a tubular terminal receiving portion 105 arranged to receive the terminal portion 103, an insulating contact prevention member 106 arranged between a peripheral wall 151a of the terminal receiving portion 105 and the insert 102 and arranged to slide along a terminal fitting direction (i.e. an arrowed N direction) of the mating terminal and the insert 102, and a coil spring 107 as an elastic member which exerts a force on the contact prevention member 106 toward the front end side of the insert 102.

As shown in FIG. 6, the terminal portion 103 includes the cylindrical insert 102, a flange portion 131 continuous with the insert 102, and an electric-wire crimp portion 132 continuous with the flange portion 131 and connected to an electric wire (not shown). There is provided a cap 104 made of insulating synthetic resin arranged to be attached to the front end of the insert 102.

The terminal receiving portion 105 includes a tubular first receiving portion 151 arranged to receive the insert 102, a tubular second receiving portion 152 arranged to receive the flange portion 131 and the electric-wire crimp portion 132, a partition wall 153 which divides between the first receiving portion 151 and the second receiving portion 152, and a tubular support portion 154 continuous with an edge of the partition wall 153. This support portion 154 is arranged such that the insert 102 is inserted into the support portion 154.

The first receiving portion 151 is provided with a stop portion 158 arranged to stop in an engaged fashion the contact prevention member 106. This stop portion 158 is formed to protrude from an inner face of the first receiving portion 151 and is arranged to prevent the contact prevention member 106 from coming off from the front.

As shown in FIG. 7, the contact prevention member 106 is formed from insulating synthetic resin and serves to prevent a foreign object (e.g. a finger) which has entered between the peripheral wall 151a of the terminal receiving portion 105 and the insert 102 from contacting the insert 102. This contact prevention member 106 includes a circular plate portion 161 having an aperture 161a into which the insert 102 is inserted, an inner tube portion 162 extending in a tubular fashion from an inner edge of the circular plate portion 161, an outer tube portion 163 extending in a tubular fashion from an outer edge of the circular plate portion 161, and a plurality of ribs 164 connecting these tube portions 162, 163. The inner tube portion 162 and the outer tube portion 163 have the same length along a longitudinal direction (i.e. an axial direction of the tube portion and a terminal fitting direction). Furthermore, a front end face 106a of the contact prevention member 106 is arranged perpendicular to the longitudinal direction of the tube portions 162, 163.

For the conventional connector 101 having the above-described structure, when a foreign object enters between the peripheral wall 151a of the terminal receiving portion 105 and the insert 102, an end of this foreign object pushes the contact prevention member 106 towards the rear side (i.e. backward) of the terminal fitting direction, and the contact prevention member 106 compresses the coil spring 107 and slides it to the rear side. As a result, the insert 102 is exposed, and the foreign object may contact the exposed insert 102.

For the above-described reason, in order to avoid the contact prevention member 106 from sliding to the rear side when the contact prevention member 106 is pushed to the rear side of the terminal fitting direction, the conventional connector 101 is provided with the coil spring 107 having large pushing force (i.e. repulsive force of the spring) to prevent the foreign object from contacting the insert 102.

### SUMMARY OF INVENTION

### Technical Problem

However, the above-described conventional connector 101 has a problem that, since the coil spring 107 has a large pushing force (i.e. a repulsive force of the spring), there is required a large force (i.e. an insertion force) to compress the coil spring 107 when inserting the insert 102 into the mating terminal. In other words, if the pushing force of the coil spring 107 is small, then the foreign object may contact the insert 102 and causes short circuit and such, and inversely, if the pushing force of the coil spring 107 is large, then the insertion force becomes large as well and the convenience is reduced. Thus, it is difficult to achieve the contact prevention of the foreign object at the same time achieving the ease of insertion into the mating terminal.

In view of the above-described problem, an object of the present invention is to provide a connector which can prevent a foreign object from contacting an insert and which can reduce the insertion force for inserting the insert into a mating terminal.

### Solution to Problem

The present invention provides, in a first aspect, a connector including a rod-shaped insert to which a mating terminal is fitted from front, a housing having a tube-shaped terminal receiving portion arranged to receive the insert, an insulating contact prevention member arranged between a peripheral wall of the terminal receiving portion and the insert, the contact prevention member being arranged to slide along a terminal fitting direction of the mating terminal and the insert, and an elastic member which exerts a force on the contact prevention member toward a front end side of the insert, wherein the contact prevention member is provided with a tapered face which is slanted radially-outward towards a rear side of the terminal fitting direction.

According to the above-described structure, since the tapered face formed at the contact prevention member is slanted radially-outward towards the rear side of the terminal fitting direction, in case the foreign object enters between the peripheral wall of the terminal receiving portion and the insert, and the contact prevention member is pushed to the rear side of the terminal fitting direction, and the contact prevention member compresses the elastic member and slides toward the rear side, the foreign object can slide on the tapered face and is guided radially-outward with respect to the insert, i.e. guided in a direction away from the insert.

The present invention provides, in a second aspect, the connector according to the first aspect, wherein the contact prevention member includes a plurality of ribs arranged at an interval along a circumferential direction of the contact prevention member, and wherein the tapered face is formed at the rib.

According to the above-described structure, the space between the adjacent ribs can be hollowed out, so the weight of the contact prevention member can be reduced, while achieving material saving and reducing the connector manufacturing cost.

### Advantageous Effects of Invention

According to the present invention, the foreign object which enters between the peripheral wall of the terminal receiving portion and the insert slides on the tapered face and is guided in a direction away from the insert. Consequently, even if the contact prevention member of the connector of the present invention slides to the same position as the contact position of the contact prevention member with respect to the insert of the conventional connector, the foreign object can be prevented from contacting the insert. In other words, for the connector of the present invention, the contact position of the contact prevention member at which the foreign object contacts the insert can be set further to the rear side than the contact position of the conventional connector. Furthermore, the compression distance of the elastic member can be set large so as to allow the contact prevention member to slide and stop before the contact position. Thus, the pushing force of the elastic member can be set small. Therefore, there can be provided the connector which can prevent the foreign object from contacting the insert and which can reduce the insertion force for inserting the insert into the mating terminal.

### BRIEF DESCRIPTION OF DRAWINGS

FIG. 1 is a cross-sectional view showing one embodiment of a connector according to the present invention;

FIG. 2 is a perspective view showing a contact prevention member which constitutes the connector shown in FIG. 1;

FIG. 3 is a front view showing a charging connector including the connector shown in FIG. 1;

FIGS. 4A, B, and C show the operation of the connector according to the prevent invention and a conventional connector, in which 4A is a cross-sectional view of the conventional connector, and 4B and 4C are cross-sectional views of the connector according to the present invention;

FIG. 5 is a front view of a charging connector including the conventional connector;

FIG. 6 is a cross-sectional view taken along a line A-A in FIG. 5; and

FIG. 7 is a perspective view showing a contact prevention member which constitutes the conventional connector.

### DESCRIPTION OF EMBODIMENTS

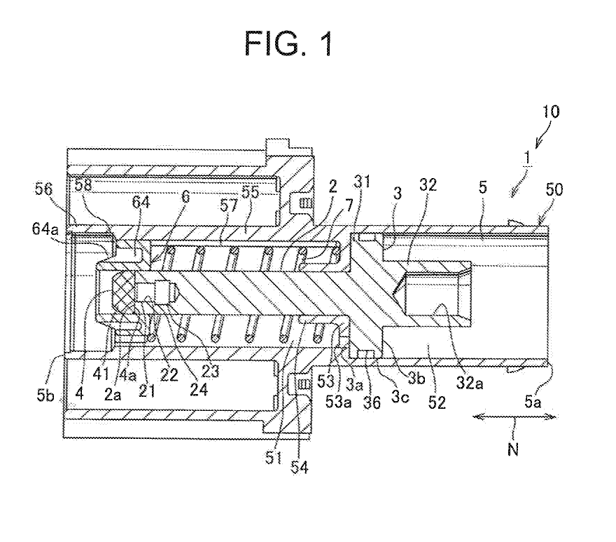

In the following, a connector according to one embodiment of the present invention is explained in reference to FIGS. 1 through 4C. The connector according to this embodiment constitutes a connector of a charging cable (hereinafter called the charging connector 10) for charging a battery of an electric vehicle and is provided with a terminal portion 3 having a rod-shaped insert 2 to which a mating terminal (not shown) is fitted from the front, a housing 50 having a tubular terminal receiving portion 5 arranged to receive the terminal portion 3, an insulating contact prevention member 6 arranged between a peripheral wall 55 of the terminal receiving portion 5 and the insert 2 and arranged to slide along a terminal fitting direction of the mating terminal and the insert 2 (i.e. an arrowed N direction), and a coil spring 7 as an elastic member which exerts a force on the contact prevention member 6 to move toward front end side of the insert 2. Here, the arrowed N direction in FIG. 1 indicates a terminal fitting direction along which the mating terminal and the insert 2 are moved toward each other and fitted to each other. This terminal fitting direction is parallel with a longitudinal direction of the insert 2 and with an axial direction of a tubular shape of the terminal receiving portion 5. Herein, mating-terminal side (left-hand side in FIG. 1) corresponds to the front side of a connector 1, and the opposite side (right-hand side in FIG. 1) corresponds to the rear side.

As shown in FIG. 1, the terminal portion 3 includes the insert 2 arranged to fit to the mating terminal, an electric-wire crimp portion 32 arranged to connect to an electric wire (not shown), and a flange portion 31 arranged between the insert 2 and the electric-wire crimp portion 32.

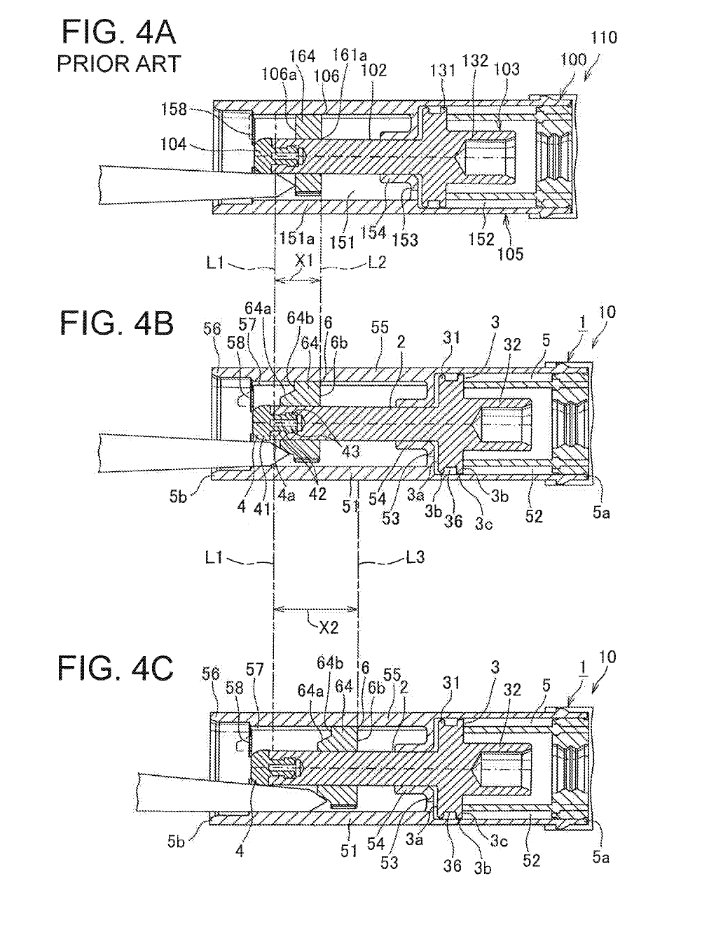

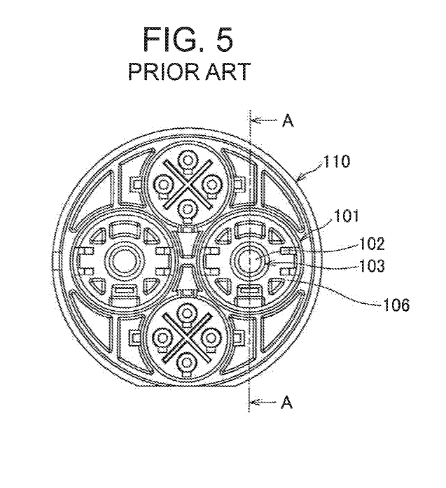

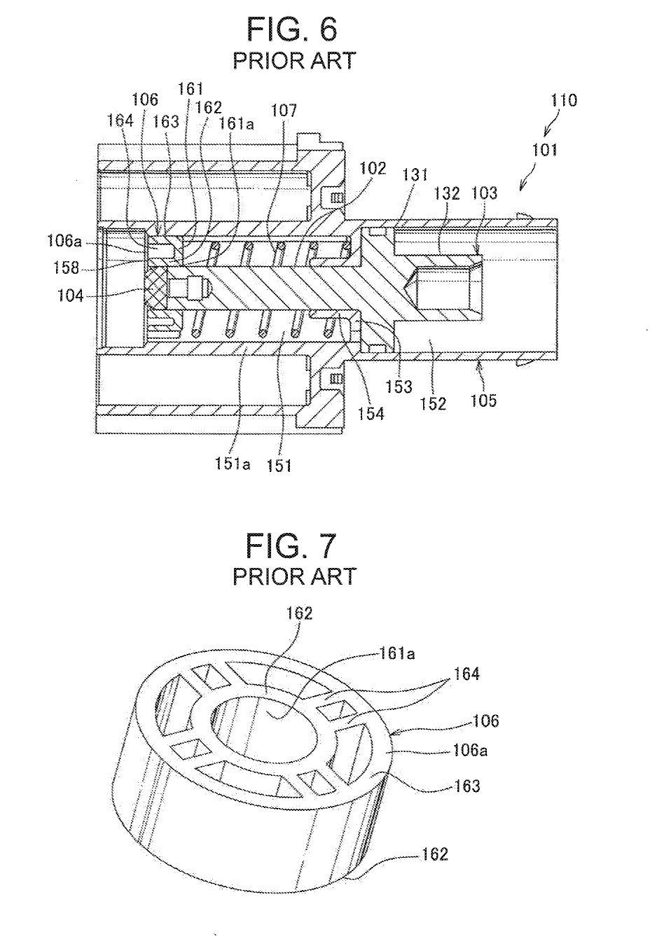

The insert 2 is formed into a cylindrical shape. There is provided a cap 4 made of insulating synthetic resin attached to a front end of the insert 2. This insert 2 has a front end face 2a which is perpendicular to the terminal fitting direction (i.e. the arrowed N direction). In addition, the front end face 2a of the insert 2 is provided with a recessed portion 21 arranged to stop in an engaged fashion a later-described claw portion 43 (shown in FIG. 4B) of the cap 4. The recessed portion 21 is arranged at a central portion of the front end face 2a of the insert 2. This recessed portion 21 includes a first inner periphery 22 continuous with an inner edge of the front end face 2a of the insert 2, a second inner periphery 23 having the diameter that is larger than the diameter of the first inner periphery 22, and a claw receive portion 24 arranged between the first inner periphery 22 and the second inner periphery 23 and is a face parallel with the front end face 2a of the insert 2. This claw receive portion 24 is arranged such that the later-described claw portion 43 of the cap 4 latches on.

The electric-wire crimp portion 32 is continuous with a rear end of the insert 2 in the terminal fitting direction via the later-described flange portion 31. In addition, the electric-wire crimp portion 32 is formed into a cylindrical shape and has the outer diameter that is larger than the outer diameter of the insert 2. A conductive portion at an end of an electric wire is inserted into a recessed portion 32a of this electric-wire crimp portion 32, and then the electric-wire crimp portion 32 is pressed in a polygonal fashion from outside by a crimping device not shown, thereby connecting the terminal portion 3 to the electric wire.

The flange portion 31 is provided with a front end face 3a located adjacent to the insert 2, a rear end face 3b located adjacent to the electric-wire crimp portion 32, and a flange-portion outer face 3c continuous with both of an outer edge of the front end face 3a and an outer edge of the rear end face 3b.

The flange-portion outer face 3c includes a groove 36 formed over the entire circumference of the flange-portion outer face 3c, wherein a waterproof rubber stopper (i.e. a waterproof packing) not shown is attached within the groove 36. The waterproof rubber stopper prevents water or dust from entering into a second receiving portion 52 (described later) of the terminal receiving portion 5.

The cap 4 is made of insulating synthetic resin. As shown in FIG. 4B, this cap 4 includes a head portion 41, a pair of arms 42 projecting from the head portion 41, and the claw portion 43 formed on a tip end of each of the pair of arms 42 and arranged to latch onto the claw receive portion 24 of the insert 2.

The head portion 41 is formed with a slant, and so it is tapered toward the front side in the terminal fitting direction. This head portion 41 is provided with an overlap face 4a which lies on the front end face 2a of the insert 2. When the cap 4 is attached to the terminal portion 3, an outer edge of the overlap face 4a and an outer edge of the front end face 2a of the insert 2 will overlap in a flat and continuous fashion.

The housing 50 is made of insulating synthetic resin. This housing 50 includes the terminal receiving portion 5 arranged to receive the terminal portion 3. The terminal receiving portion 5 is formed into a cylindrical shape extending along the terminal fitting direction (i.e. the arrowed N direction). That is, both ends 5a, 5b of the terminal receiving portion 5 in the terminal fitting direction are open and are in communication with outside of the housing 50. The terminal portion 3 is inserted into the terminal receiving portion 5 from one end 5a to the other end 5b. That is, the terminal portion 3 is inserted into the terminal receiving portion 5 from the rear side to the front side of the terminal fitting direction.

The terminal receiving portion 5 includes a tubular first receiving portion 51 arranged to receive the insert 2, a tubular second receiving portion 52 arranged continuous with the first receiving portion 51 and arranged to receive the flange portion 31 and the electric-wire crimp portion 32, and a cylindrical support portion 54 extending from an edge of a partition wall 53 to the front side of the terminal fitting direction. The insert 2 is inserted inside of the support portion 54. The first receiving portion 51 has the inner diameter that is smaller than the inner diameter of the second receiving portion 52.

The first receiving portion 51 includes the first peripheral wall 55 continuous with the second receiving portion 52, a second peripheral wall 56 continuous with the front side of the first peripheral wall 55, a guide rib 57 arranged to engage with a groove 65 (described later) of the contact prevention member 6, and a stop portion 58 arranged to stop in an engaged fashion the contact prevention member 6. There is provided an uneven surface between the first peripheral wall 55 and the second peripheral wall 56, so that the second peripheral wall 56 has the inner diameter that is larger than the inner diameter of the first peripheral wall 55.

The guide rib 57 is formed to protrude from an inner face of the first peripheral wall 55. This guide rib 57 is formed over the entire length of the first peripheral wall 55 along the terminal fitting direction (i.e. the arrowed N direction). This guide rib 57 engages with the groove 65 (described later) of the contact prevention member 6, thereby preventing the contact prevention member 6 from rotating with respect to the insert 2 in a circumferential direction of the insert 2, at the same time being slidably supported along the terminal fitting direction.

The stop portion 58 is arranged at a boundary between the second peripheral wall 56 and the first peripheral wall 55 of the first receiving portion 51. This stop portion 58 is formed to protrude from an inner face of the second peripheral wall 56. Furthermore, the stop portion 58 is arranged to stop in an engaged fashion the contact prevention member 6 such that the contact prevention member 6 is pushed further to the rear side of the terminal fitting direction (i.e. the arrowed N direction) than the stop portion 58, so the contact prevention member 6 compresses the coil spring 7 and the coil spring 7 exerts a force on the contact prevention member 6 to the front side, so that an edge 63a of an outer tube portion 63 of the contact prevention member 6 abuts on a rear end face of the stop portion 58, and by which the contact prevention member 6 is stopped in an engaged fashion at the stop portion 58. With the contact prevention member 6 being stopped in an engaged fashion at the stop portion 58, the contact prevention member 6 is prevented from coming off at the front from the terminal receiving portion 5.

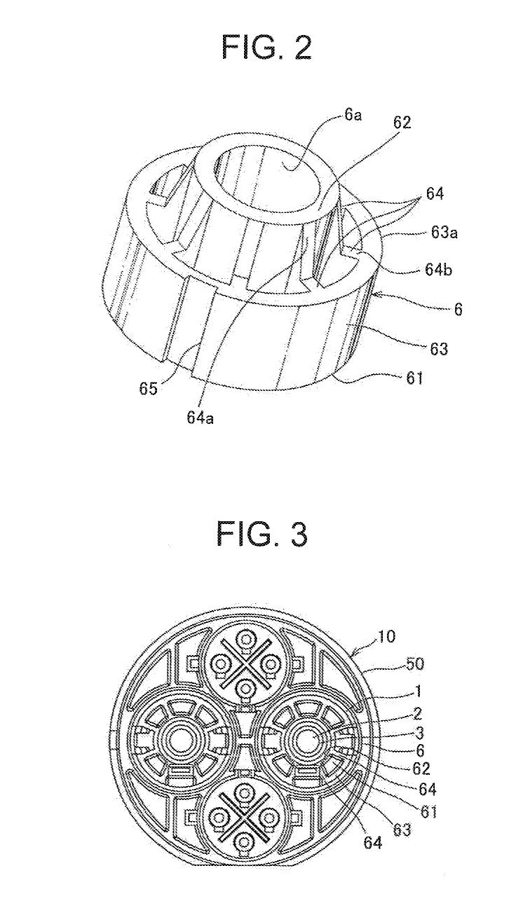

The contact prevention member 6 is made of insulating synthetic resin. As shown in FIG. 2, this contact prevention member 6 includes a circular plate portion 61 having an aperture 6a located at a center thereof into which the insert 2 is inserted, an inner tube portion 62 formed into a tubular shape and extending from an inner edge of the circular plate portion 61 to the front side of the terminal fitting direction (i.e. the arrowed N direction), an outer tube portion 63 formed into a tubular shape and extending from an outer edge of the circular plate portion 61 to the front side of the terminal fitting direction, and a plurality of ribs 64 connecting the inner tube portion 62 and the outer tube portion 63. The inner diameter of the inner tube portion 62, i.e. the diameter of the aperture 6a, is formed substantially equal to the outer diameter of the insert 2. Furthermore, the outer diameter of the outer tube portion 63 is formed substantially equal to the inner diameter of the first peripheral wall 55 of the terminal receiving portion 5.

The outer tube portion 63 is provided with the groove 65 at which the guide rib 57 of the terminal receiving portion 5 is stopped in an engaged fashion. This groove 65 is provided at an outer periphery of the outer tube portion 63. Furthermore, the groove 65 is formed over the entire length of the outer tube portion 63 along the terminal fitting direction (i.e. the arrowed N direction).

The plurality of ribs 64 is arranged at an interval along the circumferential direction of the circular plate portion 61. That is, the space between the ribs 64 located next to each other along the circumferential direction is hollowed out.

Each rib 64 includes, at a front face thereof, a tapered face 64a slanted radially-outward towards the rear side of the terminal fitting direction (i.e. the arrowed N direction), and a flat face 64b arranged continuous with the radially-outward portion of the tapered face 64a and arranged parallel with a surface of the circular plate portion 61. The inner tube portion 62 is formed larger than the outer tube portion 63 in the length along the terminal fitting direction. In such manner, since the tapered face 64a provided at the contact prevention member 6 is slanted radially-outward towards the rear side of the terminal fitting direction (i.e. the arrowed N direction), a foreign object (such as a finger) slides on the tapered face 64a and is guided away from the insert 2.

The coil spring 7 in a slightly compressed state is attached between a rear end face 6b of the contact prevention member 6 and a front end face 53a of the partition wall 53 of the terminal receiving portion 5. The coil spring 7 is mounted such that the insert 2 is passed through the coil spring 7. The rear end face 6b of the contact prevention member 6 is a seating face for a front end face of the coil spring 7, and the front end face 53a of the partition wall 53 of the housing 50 is a seating face for a rear end face of the coil spring 7.

Next, an assembling procedure of the connector 1 having the above-described structure is explained. Firstly, the cap 4 is attached in advance to the front end face 2a of the insert 2, and the waterproof rubber stopper is attached in the groove 36 of the flange portion 31 of the terminal portion 3, and an end of the electric wire is pressure bonded to the electric-wire crimp portion 32 to connect the electric wire to the terminal portion 3. Then, a side of the terminal portion 3 adjacent to the insert 2 is moved to an opening of the terminal receiving portion 5 adjacent to the other end 5b, and the terminal portion 3 is inserted into the terminal receiving portion 5 from the other end 5b of the terminal receiving portion 5. An outer face of the waterproof packing is closely-attached to an inner face of the second receiving portion 52 of the terminal receiving portion 4, and the front end face 3a of the flange portion 31 abuts on the partition wall 53 of the terminal receiving portion 5. In such manner, the insert 2 is received inside the first receiving portion 51, and the electric-wire crimp portion 32 and the flange portion 31 are received inside the second receiving portion 52, and the terminal portion 3 is received inside the terminal receiving portion 5.

Next, the coil spring 7 is mounted such that the insert 2 is passed through the coil spring 7, and the contact prevention member 6 is mounted such that the insert 2 is passed into the contact prevention member 6 from the circular plate portion 61. The contact prevention member 6 compresses the coil spring 7, and the edge 63a of the outer tube portion 63 of the contact prevention member 6 is pushed further to the rear side of the terminal fitting direction than the stop portion 58 of the terminal receiving portion 5. Then, by the pushing force (i.e. the repulsive force) of the coil spring 7, the contact prevention member 6 is pushed to the front side of the insert 2, and the contact prevention member 6 is stopped in an engaged fashion at the stop portion 58. At this time, the coil spring 7 is exerting a force on the contact prevention member 6 toward the front side of the terminal fitting direction, i.e. toward the front end side of the insert 2. In such manner, the connector 1 is assembled.

Next, the operation of the present invention is explained. In FIGS. 4A through 4C, the reference sign L1 indicates a slide start position (hereinafter called the start position) of the contact prevention member 6, 106 with respect to the insert 2, 102 for the connector 1 of the present invention and the conventional connector 101, and the reference sign L2 indicates a contact position of the contact prevention member 106 with respect to the insert 102 for the conventional connector 101 at which the foreign object contacts the insert 102, and the reference sign L3 indicates a contact position of the contact prevention member 6 with respect to the insert 2 for the connector 1 of the present invention at which the foreign object contacts the insert 2. Furthermore, FIG. 4A shows the conventional connector 101 in a state in which the foreign object is in contact with the insert 102, FIG. 4B shows the connector 1 of the present invention in a state in which the contact prevention member 6 is pushed to the contact position L2 of the conventional connector 101, and FIG. 4C shows the connector 1 of the present invention in a state in which the foreign object is in contact with the insert 2.

For the connector 1 of the present invention, since the tapered face 64a formed at the contact prevention member 6 is slanted radially-outward towards the rear side of the terminal fitting direction, in case the foreign object (e.g. a finger) enters between the first peripheral wall 55 of the terminal receiving portion 5 and the insert 2, and the contact prevention member 6 is pushed to the rear side of the terminal fitting direction (i.e. the arrowed N direction), and the contact prevention member 6 compresses the coil spring 7 and slides toward the rear side, the foreign object can slide on the tapered face 64a and is guided radially-outward with respect to the insert 2, i.e. guided in a direction away from the insert 2. Consequently, even if the contact prevention member 6 slides to the same position as the contact position L2 of the conventional connector 101, the foreign object is prevented from contacting the insert 2. In other words, as shown in FIGS. 4A and 4B, the connector 1 of the present invention can make the contact position L3 to be further to the rear side than the contact position L2 of the conventional connector 101, thereby preventing the foreign object from contacting the insert 2. In FIGS. 4A through 4C, the coil spring 7, 107 is eliminated.

The distance X1 from the start position L1 to the contact position L2 represents the distance of compression of the coil spring 107 of the conventional connector 101, and the distance X2 from the start position L1 to the contact position L3 represents the distance of compression of the coil spring 7 of the connector 1 of the present invention. As shown, the distance X2 corresponding to the compression distance of the coil spring is larger than the distance X1 corresponding to the compression distance of the conventional coil spring 107. Since the distance X2 is larger than the distance X1, the compression distance of the coil spring 7 can be set large for the connector 1 of the present invention. Thus, the pushing force of the coil spring 7 can be set small. Therefore, the insertion force for inserting the insert 2 into the mating terminal can be reduced.

Furthermore, since the space between the ribs 64 located next to each other along the circumferential direction is hollowed out, the weight of the contact prevention member 6 can be reduced, while achieving material saving and reducing the connector manufacturing cost.

The contact prevention member 6 is provided with the rib 64; however the present invention is not limited to this, and the rib 64 may be eliminated. That is, the space between the adjacent ribs 64 may be formed solid and may include the tapered face 64a formed at the front.

Furthermore, according to the above-described embodiment, the connector 1 is applied to a connector of a charging cable for charging a battery of an electric vehicle; however, the present invention is not limited to this. The present invention may be applied to a connector for connecting an electric wire and an electric wire or an electric device.

Furthermore, the coil spring 7 is mounted such that the insert 2 is passed through the coil spring 7; however, the present invention is not limited to this. The coil spring 7 may be passed though the insert 2, or alternatively the coil spring 7 may be arranged adjacent to the insert 2 in a parallel fashion. The embodiment and material of the coil spring 7 are not limited as long as the coil spring 7 can exert a force on the contact prevention material 6 to the front side of the terminal fitting direction.

The embodiments described above are only representative embodiments of the present invention, and the present invention is not limited to these embodiments. That is, the embodiments can be modified and performed in various ways without departing from the scope of the present invention.

### REFERENCE SIGNS LIST

1 connector
2 insert
5 terminal receiving portion
6 contact prevention member
7 coil spring (elastic member)
50 housing
55 peripheral wall (first peripheral wall)
64 rib
64a tapered face
N terminal fitting direction

1. A connector comprising,
a rod-shaped insert,
a housing having a tube-shaped terminal receiving portion arranged to receive the insert, an insulating contact prevention member arranged between a peripheral wall of the terminal receiving portion and the insert, the contact prevention member being arranged to slide along a direction parallel to a longitudinal direction of the insert, and
an elastic member which exerts a force on the contact prevention member toward a front end side of the insert,
wherein the contact prevention member is provided with a tapered face which is slanted radially-outward towards a direction away from the front end side of the insert along the longitudinal direction.

2. The connector according to claim 1, wherein the contact prevention member includes a plurality of ribs arranged at an interval along a circumferential direction of the contact prevention member, and wherein the tapered face is formed at the rib.
